(19) United States
(12) Patent Application Publication
(10) Pub. No.: US 2006/0139505 A1
(43) Pub. Date: Jun. 29, 2006

(54) Active matrix display device and manufacturing method of the same

(75) Inventor: Kazuhide Yoshinaga, Kanagawa (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: NEC LCD Technologies, Ltd., Kanagawa (JP)

(21) Appl. No.: 11/299,736

(22) Filed: Dec. 13, 2005

(30) Foreign Application Priority Data
Dec. 24, 2004 (JP) 374329/2004

(51) Int. Cl. G02F 1/136

(52) U.S. Cl. 349/43

(57) ABSTRACT

Active matrix display device includes connection wirings passing through a sealing material. The connection wirings are sandwiched between inorganic interlayer insulation film and an organic planarizing film. The organic film is selectively removed at a seal region to form opening portions to expose the inorganic film and to be filled with a sealing material. The sealing material contacts the lower layer inorganic interlayer insulation film in the bottom of an opening portion to increase the adhesive strength.

### BACKGROUND OF THE INVENTION

1. Field of the Invention

The present invention relates to an active matrix display device and its manufacturing method. More specifically, the present invention relates to a thin-film transistor array substrate constituting an active matrix display device and to its manufacturing method.

2. Description of the Prior Art

In recent years, active matrix liquid crystal display devices are widely used as displays with high resolution and thin film transistors (TFTs) are used as switching elements of picture elements in active matrix liquid crystal display devices. An example of such an active matrix liquid crystal display device is disclosed in Japanese Patent Laid-Open No. Hei06-258661, for example. This conventional active matrix liquid crystal display device using TFTs will be described with reference to FIGS. 1 and 2. FIG. 1 is a schematic perspective view showing the outline configuration of a conventional active matrix liquid crystal display device. FIG. 2 is a cross-sectional view showing the structure of taken along the II-II line in FIG. 1.

As shown in FIG. 1, an active matrix liquid crystal display device 200 includes a thin-film transistor array substrate 151 (hereinafter referred to as a “TFT substrate”) in which a TFT is provided to each of picture elements arranged in matrix, and a counter substrate 152 arranged to face the TFT substrate 151. A liquid crystal layer (not shown) is interposed between the substrates. A display region 142 in which picture elements are arranged in matrix, and a seal region 130A surrounding the display region 142 are provided on the TFT substrate 151. A horizontal driver 143 and a vertical driver 144, both connected to the TFTs on the display region 142 via connection wiring 108A, are provided outside the seal region 130A. Connection terminals 145 for connecting the active matrix liquid crystal display device 200 to external circuits or devices are provided on one end of the TFT substrate 151. The TFT substrate 151 and the counter substrate 152 are bonded together with a sealing material 130 arranged on the seal region 130A.

In this kind of liquid crystal display device, it is important to planarize the surface of the TFT substrate 151 in order to eliminate poor orientation of liquid crystal molecules and to increase its contrast. Thus, a planarizing film made of an organic material such as acrylic resin or epoxy resin is formed on the TFT substrate 151. With the planarizing film, the level difference produced by the presence of TFT components (e.g., a polycrystalline silicon film, a gate electrode and wirings) on the surface of the TFT substrate 151 is smoothed. At this point, the seal region 130A is also provided with a planarizing film 110, as shown in FIG. 2. The connection wiring 108A, formed in the layer where interconnections of the display region are formed, are also covered with the planarizing film 110. The sealing material 130 contacts the planarizing film 110 having a smooth surface.

In liquid crystal display devices used in cellular phones and portable terminals, a reduction in the frame width (i.e., a region from the edge of the display region 142 to the edge of the substrate) is highly required in recent years to realize the miniaturization of a device. To narrow down the frame width, it is important to narrow down the seal region 130A surrounding the display region 142, where the sealing material 130 is applied.

Meanwhile, if the TFT substrate 151 and the counter substrate 152 are weakly bonded together, both substrates will separate by a shock. And the impurities of moisture or others find its way into the liquid crystal layer and the reliability of a liquid crystal display device falls. For this reason, a high bond strength is required between the TFT substrate 151 and the counter substrate 152.

In conventional liquid crystal display devices, the planarizing film 110 is formed on the TFT substrate 151 as described above. The sealing material 130 is then arranged on planarizing film 110 with a smooth surface. The bond strength between the planarizing film 110 and the sealing material 130, or the bond strength between the planarizing film 110 and an insulating film below it is smaller than the bond strength between the sealing material 130 and an inorganic insulating film, or the bond strength between the inorganic insulating films. Thus, there has been a problem that a reduction in the width of the seal region 130A cannot be achieved because the structure using the organic planarizing film 110 is poor in bond strength.

To increase the bond strength of the organic planarizing film 110 to other components in the TFT substrate, the planarizing film 110 on the connection wiring 108A in the seal region may be removed to allow the connection wiring 108A to come in contact with the sealing material 130. In this structure, however, the connection wiring 108A are exposed and thus prone to corrosion.

In another method the planarizing film 110 on the seal region 130A may be partially removed to allow the inorganic insulating film to come into contact with the sealing material 130. Realization of this structure, however, requires an additional process in which only the planarizing film 110 is selectively removed, thereby increasing manufacturing costs.

### SUMMARY OF THE INVENTION

The present invention has been accomplished in view of the foregoing problems, and provides an active matrix display device and its manufacturing method, which can increase the bond strength between a TFT substrate and a counter substrate and can narrow down the frame width without causing the increase in manufacturing processes and the fall of reliability.

The active matrix type display of present invention is constituted by bonding a first substrate to a second substrate that counters the first substrate with a seal material. The first substrate includes a display region in which picture elements are arranged in matrix and a seal region in which the sealing material surrounding the display region is arranged. The first substrate includes a circuit unit formed outside the seal region and is connected to the display region with a connecting interconnection passing through the seal region. In the seal region of the first substrate includes at least an inorganic insulating film below the connection wiring and an organic insulating film above the connection wiring.

The organic insulating film is partially removed from the seal region, except for the region where the connection wiring is formed, to form an opening portion. And the opening portion is filled with the sealing material. The sealing material contacts with the inorganic insulating film exposed in the bottom of the opening.

In the active matrix display device of the present invention described above, the opening portion is formed at least in regions between the adjacent connection-wiring.

In the active matrix display device of the present invention described above, the organic insulating film is a planarizing film for planarizing the surface of the first substrate.

In the active matrix display device of the present invention described above, a dummy pattern, formed in the layer where the connection wiring is formed, is exposed from the bottom of the opening portion to come in contact with the sealing material. The dummy pattern is made of material selected from metallic material and inorganic material. The dummy pattern is formed at least in regions between the adjacent connection wiring.

According to the present invention, the dummy patterns, which are formed in the layer where connection wiring and inorganic insulating films that can be attached to a sealing material stronger than organic insulating films, are exposed from the opening portions provided in the seal region and come in contact with the sealing material. In addition, the presence of asperities on the seal region increases the area with which the sealing material comes in contact. Thus, the bond strength between the TFT substrate and the counter substrate can be made to increase. In the present invention it is therefore made possible to achieve miniaturization of the frame of a liquid crystal display device by narrowing down the width of the sealing material. In addition, since the planarizing film is removed except for regions where the connection wiring are provided in the present invention, it is made possible to prevent the fall of the reliability by the corrosion of the connection wiring. Furthermore, since the removal of the planarizing film is carried out simultaneously with the formation of the contact holes in the display region, the increase in manufacturing costs is also be prevented.

### BRIEF DESCRIPTION OF THE DRAWINGS

The above and other objects, features and advantages of the present invention will become more apparent from the following detailed description when taken in conjunction with the accompanying drawings wherein:

FIG. 1 is a schematic perspective view showing the configuration of a conventional liquid crystal display device;

FIG. 2 is a cross-sectional view showing the structure of a seal region, taken along the II-II line in FIG. 1;

FIG. 3 is a schematic plan view showing the configuration of an active matrix liquid crystal display device according to, a first embodiment of the present invention;

FIG. 4 is a cross-sectional view showing the structure of a TFT substrate of the active matrix liquid crystal display device according to the first embodiment of the present invention, showing the vicinity of TFTs in a display region;

FIG. 5 is a cross-sectional view showing the structure of the TFT substrate taken along I-I line in FIG. 3, showing the vicinity of connection wiring in the seal region;

FIGS. 6A and 6B are cross-sectional views each showing structural variations of opening portions according to the first embodiment of the present invention;

FIGS. 6C and 6D are plan views each showing structural variations of the opening portions according to the first embodiment of the present invention;

FIGS. 7A and 7B are plan views each showing structural variations of the opening portions according to the first embodiment of the present invention;

FIGS. 8A to 8D are cross-sectional views showing the structure of the TFT substrate of the active matrix liquid crystal display device according to the first embodiment of the present invention, and manufacturing processes;

FIG. 9 is a cross-sectional view showing the structure of a counter substrate of the active matrix liquid crystal display device according to the first embodiment of the present invention; and

FIG. 10 is a cross-sectional view showing the structure of a TFT substrate of an active matrix liquid crystal display device according to a second embodiment of the present invention, showing the vicinity of connection wiring in a seal region.

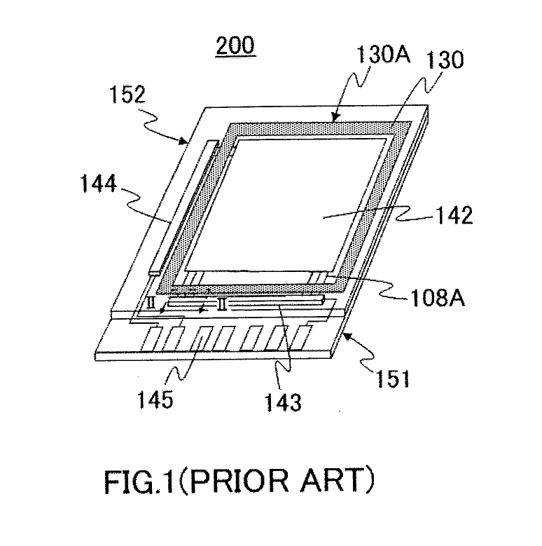

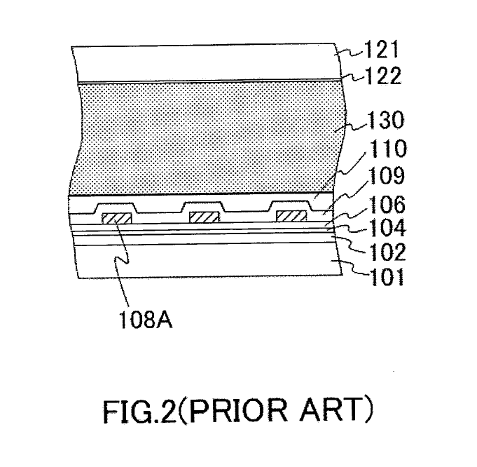

### DETAILED DESCRIPTION OF THE PREFERRED EMBODIMENTS

Preferred embodiments of an active matrix liquid crystal display device of the present invention will be described based on embodiments.

### First Embodiment

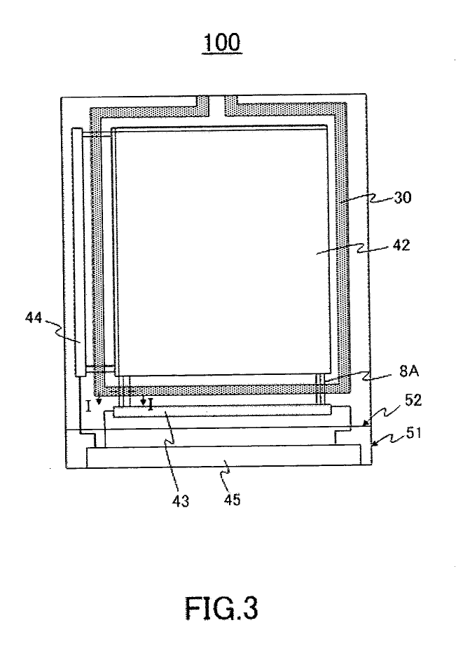

An active matrix liquid crystal display device according to a first embodiment of the present invention and a manufacturing method thereof will be first described with reference to FIGS. 3 to 9.

As shown in FIG. 3, an active matrix liquid crystal display device 100 includes a TFT substrate 51 in which switching elements (e.g., TFTs) are formed, and a counter substrate 52 arranged to face the TFT substrate 51. These substrates are bonded together with a sealing material 30. A liquid crystal material (not shown) is placed in a region surrounded by the sealing material 30. The TFT substrate 51 includes a display region 42 in which picture elements are arranged in matrix, and circuit units such as a horizontal driver 43 and a vertical driver 44 that serve to drive the picture elements. Furthermore, a connecting substrate 45 for connecting the active matrix liquid crystal display device 100 to external circuits or devices is provided on the TFT substrate 51. The sealing material 30 is so arranged that it passes over connection wiring 8A that connect the display region 42 to both the horizontal driver 43 and the vertical driver 44.

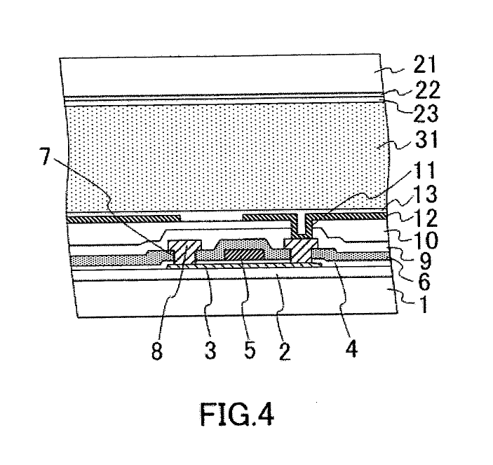

FIG. 4 is a cross-sectional view showing the structure of the TFT substrate 51, showing the vicinity of TFTs in the display region 42. A base insulating film 2 is formed on a transparent insulating substrate (e.g., a glass substrate) to prevent intrusion of heavy metals. A polycrystalline silicon film 3 is formed on the base insulating film 2. The polycrystalline silicon film 3 includes a channel region doped with almost no impurities, LDD regions doped with low concentrations of impurities, and source and drain regions doped with high concentrations of impurities. The polycrystalline silicon film 3 is then covered with a gate insulating film 4. A gate electrode 5, formed of a polycrystalline silicon film doped with impurities and a silicide film and the like, is formed on the gate insulating film 4. A first interlayer insulating film 6, formed of inorganic materials such as a silicon oxide film, a silicon nitride film or a silicon oxynitride film, is formed on the gate electrode 5.

The first interlayer insulating film 6 and the gate insulating film 4, which are provided on the source and drain regions of the polycrystalline silicon film 3, are partially removed to form contact holes 7. Wirings 8 are then formed inside and outside of the contact holes 7. Thus, the polycrystalline silicon film 3 and the wirings 8 are connected together. For the material of the wirings 8, a low-resistance metal (e.g., aluminum) is used. A second interlayer insulating film 9 is formed on the wirings 8, and a planarizing film 10, made of organic materials, is formed on the second interlayer insulating film 9 to reduce the difference in height on the surface of the TFT substrate 51. For the organic materials, acrylic resin, epoxy resin and the like can be used.

The planarizing film 10 and the second interlayer insulating film 9, which are formed on the wirings 8, are partially removed to form contact holes 11. A picture element electrode 12, made of, for example, indium tin oxide (ITO), is formed inside and outside of the contact holes 11. Thus, the wirings 8 and the picture element electrode 12 are connected together. Furthermore, an alignment film 13 is formed both on the planarizing film 10 and the picture element electrode 12′. For the material of the alignment film 13, a polyimide film or the like can be used.

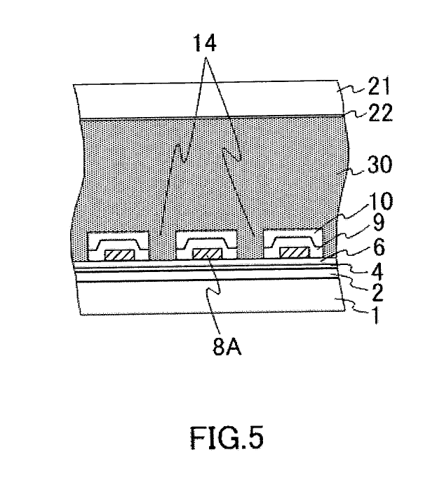

FIG. 5 is a cross-sectional view showing the TFT substrate 51, showing the vicinity of the connection wiring 8A in the seal region. The base insulating film 2, the gate insulating film 4 and the first interlayer insulating film 6 are sequentially formed on a glass substrate 1. The connection wiring 8A, which connects the display region 42 to both the horizontal driver 43 and the vertical driver 44, are formed on the first interlayer insulating film 6 so as to be in the layer where the wirings 8 in the display region 42 are formed. The second-interlayer insulating film 9 and the planarizing film 10 are then sequentially formed on the connection wiring 8A. Upon formation of the contact holes 11, the second interlayer insulating film 9 and the planarizing film 10 are partially removed with the regions where the connection wiring 8A are formed left intact. In this way opening portions 14 are formed.

The sealing material 30 is arranged on the seal region. The sealing material 30 comes in contact with the planarizing film 10 at the position near the top of the connection wiring 8A in the TFT substrate 51, and comes in contact with the exposed first interlayer insulting film 6 at the bottoms of the opening portions 14. The sealing material 30 comes in contact with a counter electrode 22 and connects the TFT substrate 51 to the counter substrate 52. Furthermore, a liquid crystal material 31 is held between the TFT substrate 51 and the counter substrate 52, thereby constituting the active matrix liquid crystal display device of this embodiment.

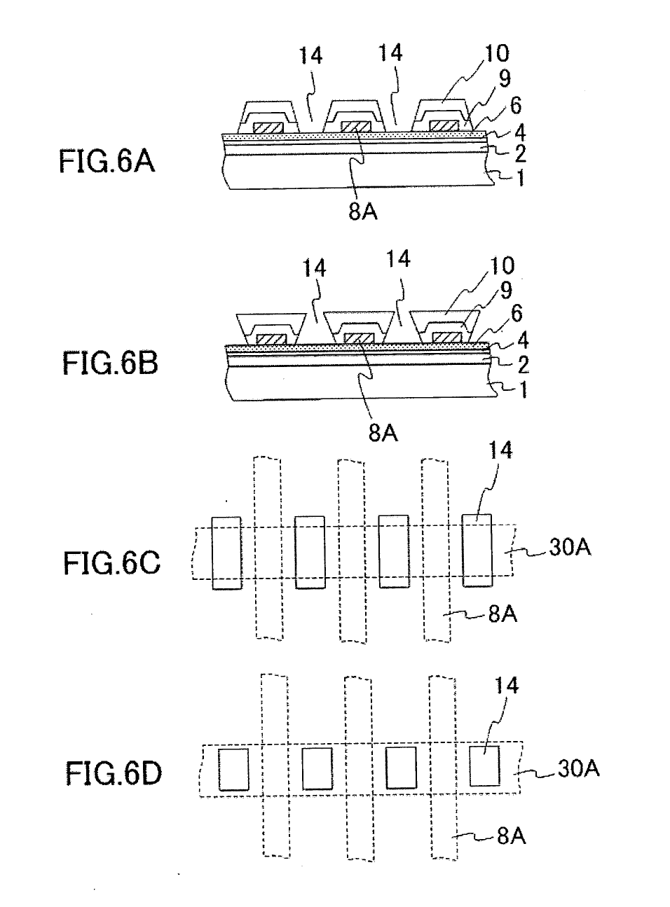

It should be noted that the opening portions 14 are only required to be formed in the seal region in such a way that they never overlap with the connection wiring 8A when seen from the direction of the normal to the substrates. The width (i.e., horizontal width in FIG. 5) of the opening portions 14 is not limited to the configuration shown in FIG. 5. Although the walls of the opening portions 14 are vertical in FIG. 5, their shape in the depth direction (i.e., vertical direction in FIG. 5) is not limited to the configuration shown in FIG. 5 either. For example, the opening portions 14 may have a tapered shape as shown in FIG. 6A. The opening area of the surface is larger than the bottom area. Alternatively, they may have a shape as shown in FIG. 6B. Both the opening area of the surface and the center area are smaller than the bottom area. The length (i.e., the length of the direction in which the connection wiring 8A extend) of the opening portions 14 is also not particularly limited. For example, the opening portions 14 may be provided to pass trough the seal region 30A as shown in FIG. 6C, or may be provided within the seal region 30A as shown in FIG. 6D. The shape of the opening portions 14 is not also limited to the configuration shown in FIG. 5. They may be circular, oval, polygonal or the like in shape.

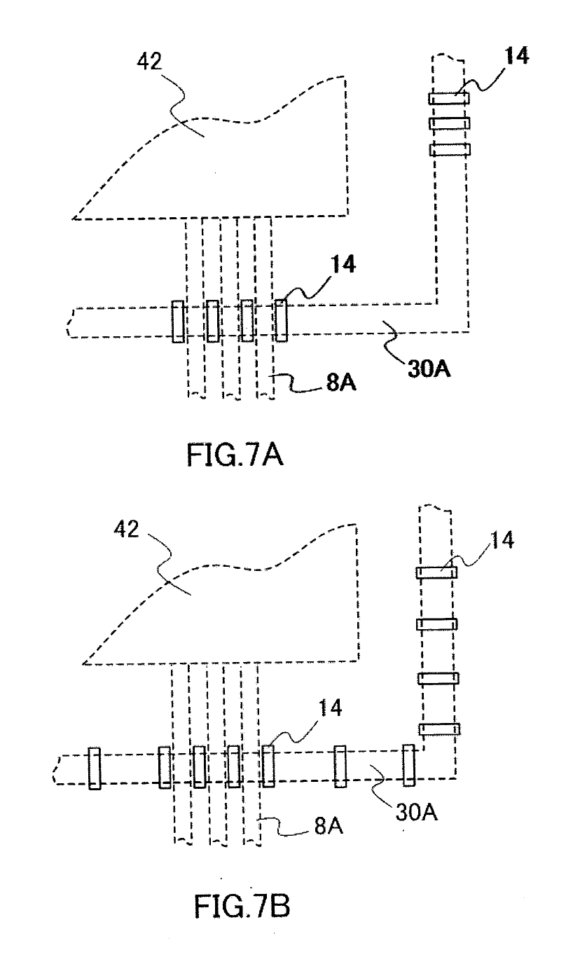

Moreover, the opening portions 14 are only required to be formed in positions where the connection wiring 8A are not formed. The position where they are formed, the number of them, and the interval between them are not particularly limited. For example, they may be formed only between the adjacent connection wiring 8A as shown in FIGS. 5, 6A and 6B, or they may be formed not only between the adjacent connection wiring 8A, but also in regions where the connection wiring 8A are not formed, as shown in FIG. 7A. When forming a plurality of opening portions 14, all of them do not necessarily have to have the same width or length. For example, there may be provided wide and narrow opening portions 14 in combination. The opening portions 14 do not necessarily have to be provided at even intervals; they may be different distances apart as shown in FIG. 7B.

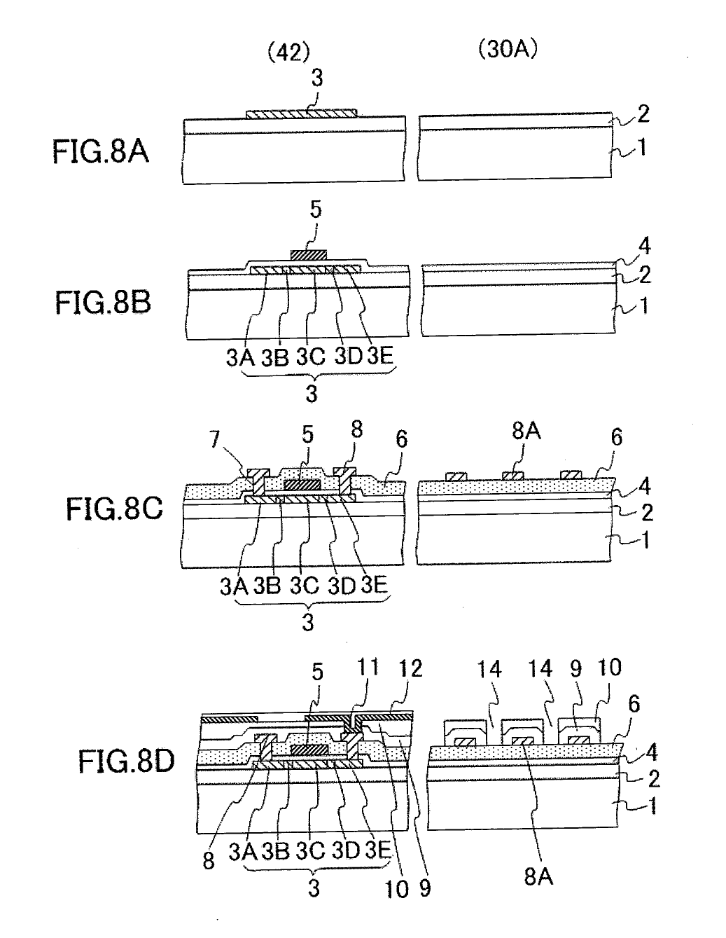

Next, the manufacturing method of the TFT substrate 51 will be described with reference to FIGS. 8A to 8D. FIGS. 8A to 8D are cross-sectional views each showing the structure of the TFT substrate 51 in the manufacturing stage. The left side of each drawing shows the structure of the TFT substrate 51 near the TFTs in the display region 42, corresponding to FIG. 4. The right side of each drawing shows the structure of the TFT substrate 51 near the connection wiring 8A in the seal region 30A, corresponding to FIG. 5.

First, as shown in FIG. 8A, the base insulating film 2 is deposited on the surface of a transparent insulating substrate (e.g., the glass substrate 1) by Chemical Vapor Deposition (CVD). For the base insulating film 2, a silicon oxide film or a silicon nitride film can be used.

An amorphous silicon film (not shown) is then deposited on the base insulating film 2 by, for example, Low Pressure CVD (LPCVD) or Plasma CVD (PCVD). The deposited amorphous silicon film is crystallized by, for example, laser annealing. The amorphous silicon film converts to a polycrystalline silicon film. Subsequently, the polycrystalline silicon film is patterned by photolithography and etching. In this way the polycrystalline silicon film 3 is formed that functions as an active layer of a thin film transistor.

Next, as shown in FIG. 8B, the gate insulating film 4 formed of, for example, a silicon oxide film, is formed on the base insulating film 2 and the polycrystalline silicon film 3 by CVD. A lamination film, formed of a polycrystalline silicon film doped with impurities and a silicide film (both of which are not shown), is then formed on the gate insulating film 4. This lamination film is patterned by photolithography and etching to form the gate electrode 5.

Next, the polycrystalline silicon film 3 is selectively doped with low concentrations of impurities while using the gate electrode 5 as a mask. The polycrystalline silicon film 3 is then selectively doped with high concentrations of impurities while using the patterned photoresist film as a mask. In this way, source and drain regions 3A and 3E, Lightly Doped Drain (LDD) regions 3B and 3D, and a channel region 3C are respectively formed on the polycrystalline silicon film 3. The substrate is then annealed at around 600° C. to activate the doped impurities.

Next, as shown in FIG. 8C, the first interlayer insulating film 6 is formed on the gate insulating film 4 and the gate electrode 5 by CVD. For the material of the first interlayer insulating film 6, a silicon oxide film, a silicon nitride film, a silicon oxynitride film or the like can be used. The first interlayer insulating film 6 and the gate insulating film 4, provided on the source and drain regions of the polycrystalline silicon film 3, are then selectively removed by photolithography and etching to form the contact holes 7. An aluminum film (not shown) is then deposited on the first interlayer insulating film 6 by sputtering. The deposited aluminum film is patterned by photolithography and etching to form the wirings 8. The wirings 8 are also formed inside the contact holes 7 and are electrically connected to the source and drain regions of the polycrystalline silicon film 3. Upon formation of the wirings 8, the connection wiring 8A are formed that connect the display region 42 to both the horizontal driver 43 and the vertical driver 44.

Next, as shown in FIG. 8D, the second interlayer insulating film 9 formed of, for example, a silicon oxide film, is formed by CVD so as to cover the first interlayer insulating film 6, the wirings 8 and the connection wiring 8A. Subsequently, the planarizing film 10 is applied on the second interlayer insulating film 9. For the material of the planarizing film 10, organic materials such as acrylic resin and epoxy resin can be used. At this time, the second interlayer insulating film 9 and the planarizing film 10 are also formed on the entire surface of the seal region.

Next, the planarizing film 10 and the second interlayer insulating film 9 on the wirings 8 provided on the source and drain regions are selectively removed by photolithography and etching to form the contact holes 11 from which the interconnections are exposed. At this time, parts of the second insulating film 9 and the planarizing film 10 in the seal region 30A are selectively removed, with the regions where the connection wiring 8A are formed left intact. In this way the opening portions 14 are formed, from which the first interlayer insulating film 6 is exposed. Subsequently, an ITO film is formed on the planarizing film 10 in each picture element provided in the display region. The ITO film is then patterned by photolithography and etching to form the picture element electrode 12. The picture element electrode 12 is also formed inside the contact holes 11 and is electrically connected to the wirings 8. A polyimide film is then applied onto the planarizing film 10 and onto the picture element electrode 12 in the display region (the polyimide film may be arranged thereon by a transfer method) to form the alignment film 13. In this way the TFT substrate 51 of this embodiment is formed.

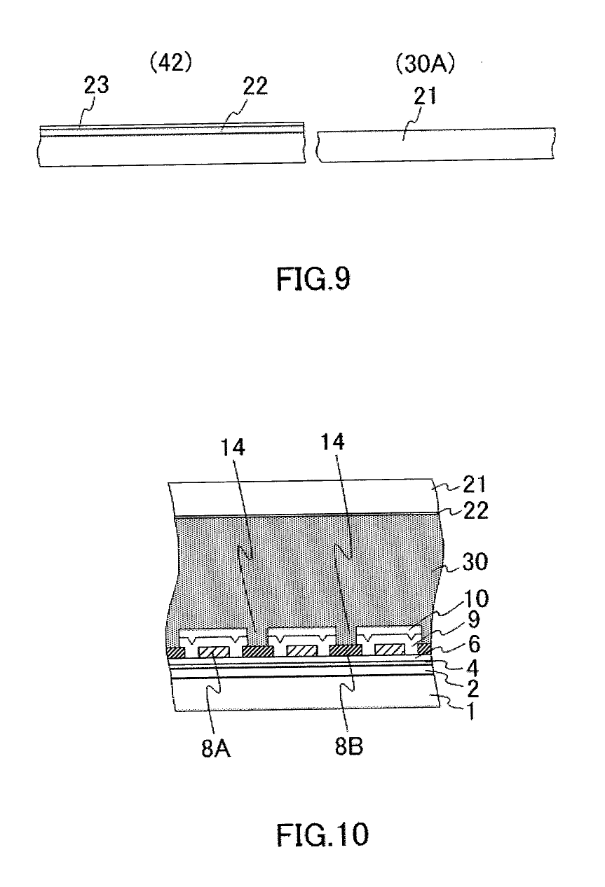

In addition, the manufacturing method of the counter substrate 52 will be described with reference to FIG. 9. An ITO film (not shown) is deposited on a glass substrate 21 by sputtering. The ITO film is then patterned by photolithography and etching to form a counter electrode 22. A polyimide film is applied onto the counter electrode 22 (the polyimide film may be arranged thereon by a transfer method) to form an alignment film 23. In this way the counter substrate 52 is formed.

The TFT substrate 51 and the counter substrate 52 are bonded together with the sealing material 30. The liquid crystal material 31 is then sealed between the TFT substrate 51 and the counter substrate 52. Thus, an active matrix liquid crystal display device is manufactured.

As described above, according to the active matrix liquid crystal display device and the manufacturing method thereof in this embodiment, the second interlayer insulating film 9 and the planarizing film 10, arranged in the seal region, are partially removed to form the opening portions 14. The first interlayer insulating film 6 made of inorganic materials is exposed from the bottoms of the opening portions 14. The sealing material 30 can be attached firmly to the first interlayer insulating film 6 via the opening portions 14. In this embodiment, a synergistic effect can be achieved for the increase in the adhesion property of the sealing material 30, which results from the following facts: the sealing material 3G is in contact with the first interlayer insulating film 6, and the surface where the sealing material 30 is applied has asperities. Furthermore, since the connection wiring 8A never be exposed as a result of the formation of the opening portions 14, the second interlayer insulating film 9 and the planarizing film 10 can maintain the protection of the connection wiring 8A. In this embodiment it is possible to increase the bond strength between the TFT substrate 51 and the counter substrate 52 by use of the sealing material 30. As a consequence, it is made possible to narrow down the width of the seal region and thus to achieve the miniaturization of the frame of the liquid crystal display device.

It should be noted that the planarizing film 10 and the second interlayer insulating film 9 that serve to electrically connect the wirings 8 to the picture element electrode 12 need to be completely removed from the contact holes 11 in the display region. In the opening portions 14 in the seal region, organic insulating films such as the planarizing film 10 may be removed to expose inorganic insulating films. If the second interlayer insulating film 9 is formed of inorganic materials such as a silicon oxide film, a silicon nitride film or a silicon oxynitride film, it is possible to obtain the effect of the present invention even when a part of the second interlayer insulating film 9 is remained in the opening portions 14.

### Second Embodiment

Next, an active matrix liquid crystal display device according to a second embodiment of the present invention and a manufacturing method thereof will be described with reference to FIG. 10. FIG. 10 is a cross-sectional view showing the structure of a TFT substrate of the active matrix liquid crystal display device according to the second embodiment of the present invention, showing the vicinity of connection wiring in a seal region.

In the foregoing first embodiment, the first interlayer insulating film 6 is used as an etching stopper layer at the time when the planarizing film 10 and the second interlayer insulating film 9 are removed. This method, however, may have problems if there is not a sufficient difference in etching rate between the first interlayer insulating film 6 and the planarizing film 10 or the second interlayer insulating film 9. For example, the first interlayer insulating film 6 may be undesirably etched.

Thus, in this embodiment, dummy patterns 8B made of a low-resistance metal layer such as aluminum, which never contribute to electrical connection, are formed in the seal region where the opening portions 14 are to be formed, together with the connection wiring 8A as shown in FIG. 10. In this structure the dummy patterns 8B function as a stopper layer at the time when the contact holes 11 are formed. The formation of the dummy patterns 8B can prevent the aforementioned etching of the first interlayer insulating film 6.

The connection wiring 8A and the dummy patterns 8B have the same shape in FIG. 10. But, the width, length, shape and the like of the dummy patterns 8B are not particularly limited. The dummy patterns 8B may have a wide or narrow width. The dummy patterns 8B may be provided to pass trough the seal region, or may be provided within the seal region. Moreover, the dummy patterns 8B may be circular, oval, or polygonal in shape. Although the dummy patterns 8B are provided between the adjacent connection wiring 8A and outside of the connection wiring 8A arranged on the ends of the TFT substrate in FIG. 10, the positions where they are formed can be appropriately determined depending on the positions where the opening portions 14 are formed. In addition, the opening portions 14 are only required to lie within the dummy patterns 8B when seen from the direction of the normal to the substrates. The width, length, shape and the like of the opening portions 14 are not particularly limited. It should be noted that the description of the manufacturing method of the TFT substrate 51 of this embodiment is omitted because it is possible to manufacture the TFT substrate 51 in a process similar to that described in the first embodiment, except for the formation of the dummy patterns 8B.

According to the active matrix liquid crystal display device of this embodiment, upon formation of the connection wiring 8A in the seal region, the dummy patterns 8B are formed between the adjacent connection wiring 8A and at both ends of the TFT substrate so as to be in the layer where the connection wiring 8A are formed. The second interlayer insulating film 9 and the planarizing film 10 in the seal region are removed using these dummy patterns 8B as etching stoppers, thereby forming the opening portions 14. The dummy patterns 8B, made of metallic material that increases its adhesion strength to the sealing material 30, are exposed from the opening portions 14. In this embodiment, a synergistic effect can be achieved for the increase in the adhesion property of the sealing material 30, which results from the following facts: the sealing material 30 is in contact with the dummy patterns 8B in the opening portions 14; and the surface to which the sealing material 30 is applied has asperities. As a result, it is possible to increase the adhesion strength between the TFT substrate 51 and the counter substrate 52 that are bonded together via the sealing material 30, and to narrow down the width of the seal region. It is, therefore, made possible to miniaturize the frame of the liquid crystal display device.

It should be noted that each of the foregoing embodiments adopts a structure that has the second interlayer insulating film provided between the first interlayer insulating film 6 made of inorganic material and the planarizing film 10 made of organic material. In the present invention it is sufficient that there is provided at least an organic insulating film above an inorganic insulating film. A similar effect can also be obtained with a configuration that has no second interlayer insulating film or with a configuration that has other additional insulating films. In addition, although a low-resistance metal such as aluminum is used as the dummy patterns 8B in the foregoing second embodiment, dummy patterns 8B made of inorganic material such as silicon oxide may be provided.

Although the structure of the present invention is applied to the TFT substrate in which TFTs are used as switching elements in the foregoing embodiments, the present invention is not limited to the foregoing embodiments. The present invention can similarly be applied to an active matrix substrate in which switching elements other than TFTs are used.

It goes without saying that the present invention can similarly be applied to any display device formed by bonding an active matrix substrate to a counter substrate with a sealing material, such as display devices using organic EL elements.

While this invention has been described in connection with certain preferred embodiments, it is to be understood that the subject matter encompassed by way of this invention is not to be limited to those specific embodiments. On the contrary, it is intended for the subject matter of the invention to include all alternative, modification and equivalents as can be included within the sprit and scope of the following claims.

What is claimed is:

1. An active matrix display device comprising:
a first substrate having picture elements arranged in matrix to form a display region;
a second substrate bonded to the first substrate by using a sealing material so as to provide a seal region surrounding the display region;
a group of connection wirings formed on the first substrate to pass through the sealing material such that one ends of the connection wirings are connected to the picture elements and the other ends thereof are located outside of the sealing material;
an inorganic insulating film provided under the connection wirings; and
an organic insulating film provided on the connection wirings, the organic insulating film being selectively removed at the seal region to form an opening portion filled with the sealing material except for regions on the connection wirings.

2. The active matrix display device according to claim 1,
wherein the opening portion is formed at least in regions between the adjacent connection wirings.

3. The active matrix display device according to claim 1,
wherein the inorganic insulating film is exposed from the bottom of the opening portion to come in contact with the sealing material.

4. The active matrix display device according to claim 1,
wherein the organic insulating film is a planarizing film for planarizing the surface of the first substrate.

5. The active matrix display device according to claim 1,
wherein a dummy pattern, formed in the layer where the connection wirings are formed, is exposed from the bottom of the opening portion to come in contact with the sealing material.

6. The active matrix display device according to claim 5,
wherein the dummy pattern is made of material selected from a metallic material and an inorganic material.

7. The active matrix display device according to claim 5,
wherein the dummy pattern is formed at least in regions between the adjacent connection wirings.

8. A manufacturing method of an active matrix display device comprising:
forming a thin film transistor on a display region of a first substrate;
forming an inorganic insulating film on the thin film transistor;
removing the inorganic insulating film on an electrode of the thin film transistor to form a first through hole;
forming a first connection wiring and a second connection wiring such that the second connection wiring is connected via the first through hole to an electrode of the thin film transistor;
forming at least an organic insulating film on the first connection wiring and the second connection wiring;
removing a part of the organic insulating film on the second connection wiring of the display region to form a second through hole, and removing a part of the organic insulating film in a seal region, except for the region where the first connection wiring is formed, to form a opening portion; and
forming on the display region a picture element electrode connected to the second connection wiring via the second through hole; and
bonding a second substrate to the first substrate by using a sealing material at the seal region such that the first connection wiring and the second connection wiring are passed through the sealing material and the opening portion is filled with the sealing material.

9. The manufacturing method according to claim 8,
wherein the opening portion is at least formed in regions between the adjacent first connection wirings.

10. The manufacturing method according to claim 8,
wherein the step of forming the first connection wiring includes a step of forming a dummy pattern on the seal region of the inorganic insulating film where the opening portion is formed.

11. The manufacturing method according to claim 10,
wherein material selected from metallic material and inorganic material is used for the material of the dummy pattern.

12. The manufacturing method according to claim 10,
wherein the dummy pattern is formed at least in regions between the adjacent second connection wirings.

13. The manufacturing method according to claim 10,
wherein the organic insulating film is a planarizing film for planarizing the surface of the first substrate.
